(19) United States
(12) Patent Application Publication
(10) Pub. No.: US 2025/0376635 A1
(43) Pub. Date: Dec. 11, 2025

(54) Method of Synthesising Polyols and Polyurethane Rigid Foams from Food Waste

(71) Applicant: City University of Hong Kong, Kowloon (HK)

(72) Inventors: Sze Ki Carol Lin, Kowloon (HK); Zihao Qin, Wuhu (CN); Mikelis Kirpluks, Riga (LV); Anda Fridrihsone, Riga (LV)

(21) Appl. No.: 19/229,228

(22) Filed: Jun. 5, 2025

Related U.S. Application Data
(60) Provisional application No. 63/657,182, filed on Jun. 7, 2024.

(51) Int. Cl. C11C 1/04; C08J 9/00; C08J 9/14

(52) U.S. Cl. CPC C11C 1/045; C08J 9/0038; C08J 9/146; C08J 2203/162; C08J 2205/10; C08J 2375/08

(57) ABSTRACT

A method of forming polyurethane rigid foams includes hydrolysing an amount of food waste, extracting lipids from the hydrolysed food waste, forming polyols from the lipid, and forming polyurethane rigid foams with the polyols.

This invention relates to a method of synthesising bio-based polyols for further development of polyurethane rigid foams (PURFs) and a method of synthesising PURFs with such bio-based polyols, in particular, from food waste.

For conciseness purposes, the following abbreviations are adopted in the subsequent discussion:
AOC Annual operation cost
ATR Attenuated total reflectance
BCA Bicinchoninic acid
DEG Diethylene glycol
DFC Direct fixed capital
FDC Facility-dependent cost
FFA Free fatty acid
FTIR Fourier-transform infrared
FW Food waste
FWLs Food waste lipids
GC Gas chromatography
GPC Gel permeation chromatography
HBF₄ Fluoroboric acid
HPLC High-performance liquid chromatography
IRR Internal rate of return
Lab/QA/QC Laboratory/quality assurance/quality control
LSIWC Latvian State Institute of Wood Chemistry
MALS Multi-angle light scattering
MS Mass spectrometry
NHLs Non-hydrolysed lipids
NPV Net present value
PC Equipment purchase cost
pMDI Polymeric 4,4′-methylene diphenyl isocyanate
PU Polyurethane
PURF Polyurethane rigid foams
RCO Relative conversion to oxirane
REU Relative ethylenic unsaturation
RI Refractive index
ROI Return on investment
SEC Size exclusion chromatography
TCPP Tris(1-chloro-2-propyl)phosphate
TEA Techno-economic analysis
TGA Thermogravimetric analysis
THF Tetrahydrofuran
TN Total nitrogen

### BACKGROUND OF THE INVENTION

Food waste (FW) is one of the most critical concerns for achieving sustainable development. According to the United Nations Environment Programme, in 2019, approximately 931 million tonnes of FW were generated by retailers and consumers globally, with 61%, 26%, and 13% originating from households, food service, and retail sources, respectively. Moreover, while the global food system resulted in 18.6 billion tonnes (Gt) of greenhouse-gas emissions, worldwide food loss and waste from the supply chain and waste management systems contributed to emissions of approximately 9.3 billion tonnes of CO₂ equivalent in 2017. To address the environmental impacts associated with FW, various solutions have been proposed to reduce or efficiently recycle FW. In this regard, FW biorefineries have garnered significant attention as a promising solution in recent years. Despite compositional variations across sources, FW typically contains considerable amounts of diverse nutrients, including carbohydrates, proteins, and lipids. A FW biorefinery recognises these nutrients as valuable resources and transforms them into a broad spectrum of bio-based products via a sequence of economically feasible and low-impact technical processes. Notably, most of the existing research has focused on recovering fermentable sugars from FW to produce various value-added products, including biofuels, organic acids, biopolymers, biosurfactants, and enzymes. In the meantime, the technological diversity of utilising the lipid fraction from FW is relatively limited: in many cases, FW lipids (FWLs) were investigated as the feedstock for biodiesel. Given this, consideration should be given to exploring alternative possibilities for the valorisation of FWLs.

Polyurethane (PU) represents a class of diverse polymers composed of organic units joined by carbamate (urethane) linkages. Typically, PU is derived from the reactions of fossil-based polyols and isocyanates. Various chemical nature of these building blocks enables the structure design of PU with tailored characteristics, exhibiting thermoplastic, elastomeric, or thermoset behaviours. Owing to these remarkably versatile properties, PU is widely applied in different industrial sectors, such as insulation, sealants, coatings, elastomers, adhesives, and adsorbents. To promote sustainability, researchers are exploring renewable substitutes for producing PU. For instance, bio-based polyols can be derived from lignin, vegetable oils, and microalgal oil, and then further developed into PU rigid foams (PURF). Moreover, the bio-based PURF exhibited excellent characteristics for different applications, which could compete with petrochemical materials. Similarly, FWLs can be considered as a renewable alternative for the manufacture of PURF. This approach enhances the diversity of the previously mentioned FW biorefinery and ensures proper waste management while promoting the sustainable development of relevant polymer industries. Although prior research has demonstrated the feasibility, questions remain regarding utilising FWLs to produce PURF, particularly the reaction mechanisms, detailed production procedures, economic viability, and so on. It is thus an objective of the present invention to provide a method of forming polyols and polyurethane rigid foams with food waste in which at least one of the aforesaid shortcomings is mitigated or to provide a useful alternative to the industry and public.

### SUMMARY OF THE INVENTION

According to a first aspect of the present invention, there is provided a method of forming bio-based polyols, including hydrolysing an amount food waste, extracting lipids from said hydrolysed food waste, and forming polyols from said lipids.

According to a second aspect of the present invention, there is provided a method of forming polyurethane rigid foams, including hydrolysing an amount of food waste, extracting lipids from said hydrolysed food waste, forming polyols from said lipids, and forming polyurethane rigid foams with said polyols.

### BRIEF DESCRIPTION OF THE DRAWINGS

Embodiments of the present invention will now be described, by way of example only, with reference to the accompanying drawings, in which:

FIG. 1 is a schematic diagram of the general arrangement for implementing a method of forming bio-based polyols and bio-based PURF according to an embodiment of the present invention;

FIGS. 2a to 2f show non-linear (power function) fitting curves of a values for major equipment types used in the present invention, with data on capacities and costs extracted from SuperPro Designer v13 built-in cost models, and statistical analysis performed by using GraphPad Prism;

FIG. 3a shows the free fatty acid (FFA) content profile and one-phase association non-linear fitting during FW hydrolysis under various lipase dosages;

FIG. 3b shows the glucose concentration profile and one-phase association non-linear fitting during FW hydrolysis under various glucoamylase dosages;

FIG. 3c shows lipid recovery in the crude lipid phase under various lipase dosages;

FIG. 3d shows lipid recovery in the hydrolysate phase under various lipase dosages;

FIG. 3e shows lipid recovery in the remaining solid phase under various lipase dosages;

FIG. 3f shows carbohydrate recovery in each phase under various glucoamylase dosages;

FIG. 3g shows FW composition on a dry basis;

FIG. 3h shows the total nitrogen (TN) profile and one-phase association non-linear fitting during FW hydrolysis under various protease dosages, the moisture content of the FW being 60.04±1.87%, each error bar representing the standard deviation of at least three samples, and no denotation being presented unless a significant difference (*p<0.05) was found between the two groups;

FIG. 4a shows an exemplary experimental scheme for the development of PURF from FW;

FIG. 4b shows the GC-MS chromatogram of the FWLs;

FIG. 4c shows the GPC chromatogram of the FWLs and the FWL-derived epoxides;

FIG. 4d shows FTIR spectra of the FWLs, the FWL-derived epoxides, and the FWL-derived polyols;

FIG. 4e shows the profile of relative conversion to oxirane during epoxidation of the FWLs;

FIG. 4f shows the GPC chromatogram of the FWL-derived polyols;

FIG. 4g shows a rise curve and characteristics of the FWL-derived PURF;

FIG. 5a shows GC-MS chromatogram of non-hydrolysed lipids (NHLs);

FIG. 5b shows the GPC chromatogram of NHLs-derived epoxides;

FIG. 5c shows FTIR spectra of NHLs, NHL-derived epoxides, and NHL-derived polyols;

FIG. 5d shows profile of relative conversion to oxirane during epoxidation of NHLs;

FIG. 5e shows the GPC chromatogram of NHL-derived polyols;

FIG. 5f shows a rise curve and characteristics of NHL-derived PURF;

FIG. 6 shows a thermogravimetric curve of FWLs-derived PURF;

FIG. 7a shows a schematic diagram of a base case of implementation of an embodiment of the present invention;

FIG. 7b shows the breakdown of the unit production cost (2.04 US$/kg PURF) in the base case;

FIG. 7c shows cumulative cash flow at different discount rates;

FIG. 8 shows a SuperPro flowsheet of Area 1 and Area 2 in the base case;

FIG. 9a shows a sensitivity analysis of the base case, with the base net present value (NPV) being US$148,782,560;

FIG. 9b shows variation in NPV and payback time in response to the FW processing rate;

FIG. 10a shows a schematic diagram of a base case of implementation of another embodiment of the present invention; and

FIG. 10b shows a flowsheet of Area A, Area B, Area C and Area D in the base case of FIG. 10a.

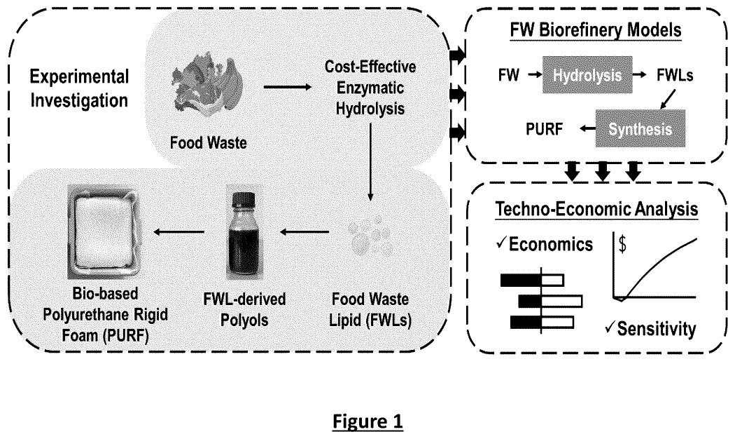

### DETAILED DESCRIPTION OF THE EMBODIMENTS

To implement an embodiment of the present invention, FW was collected from the City Chinese Restaurant at the City University of Hong Kong. After collection, irrelevant components, such as bones, tissue paper, and plastic items, were removed. The FW was then blended and mixed for homogeneity and stored at −20° C. before further hydrolysis.

FW hydrolysis was performed in a 2.5-L bioreactor (New Brunswick Scientific, USA). First, the FW was mixed with tap water to maintain a solid-to-liquid ratio of 30 w/v %. Three enzymes, i.e., glucoamylase (260,000 U/mL), neutral protease (50,000 U/g), and lipase (100,000 U/g), were added in various dosages (0.05 to 5 v/w or w/w % of FW) to perform enzymatic hydrolysis. All enzymes were purchased from Sunson Biotechnology Co. Ltd. (Shanghai, China). A dosage of 1 v/w or w/w % of all three enzymes was set as the control condition. Hydrolysis was performed for 6 to 36 hours (h) at 35-70° C. (such as 55° C.) and 100-500 rpm (such as 300 rpm) without pH adjustment. Samples were taken at different time intervals to monitor the progress of hydrolysis. Upon completion, the hydrolysed FW was subjected to centrifugation at 8000 rpm for 20 min. Subsequently, the three phases separated by centrifugation, i.e., the crude lipids, hydrolysate, and remaining solids, were carefully quantified in terms of weight or volume. Furthermore, the nutritional compositions of the three phases were analysed using the methods to be described. Samples were stored at −20° C. prior to the analysis.

The total lipid content was gravimetrically measured after solvent extraction. Specifically, 50 mg of freeze-dried samples was mixed with 1.5 mL of 5% sodium chloride solution, 2 mL of methanol, and 2 mL of chloroform. After strong vortexing and centrifugation at 3,000 rpm for 3 min, the organic phase was carefully pipetted into a pre-weighed tube. Subsequently, the extraction procedure was repeated two times with additional chloroform. The collected organic phase was finally dried under a nitrogen stream and weighed to determine the total lipid content. Lipid recovery in each phase (the crude lipids, hydrolysate, or remaining solids) is calculated as the percentage of total lipid content in that phase divided by the total lipid content in the total FW.

The free fatty acid (FFA) content was determined following an existing approach (see E. Varona, A. Tres, M. Rafecas, S. Vichi, A. C. Barroeta, F. Guardiola, Methods to determine the quality of acid oils and fatty acid distillates used in animal feeding, MethodsX 8 (2021) 101334, and S. S. Nielsen, Food Analysis Laboratory Manual, 3rd 2017 ed., Springer Nature, Cham, 2017) with minor modifications. During hydrolysis, approximately 10 g of the FW slurry sample was removed from the reactor and subjected to lipid extraction following the procedures described in the determination of total lipid content. The obtained lipid-containing chloroform was transferred to a 250 mL shake flask, to which 95% ethanol and the phenolphthalein indicator were added. This mixture was titrated against a standard 0.05 N sodium hydroxide solution. Each batch of sodium hydroxide solution was standardised against a standard sulfuric acid solution. The back-calculated value for the concentration of the sodium hydroxide solution was used to determine the FFA content using Equation (1). For each sample, extraction and titration were performed in triplicate.

$$Free fatty acid content = \frac{V * N * 282}{W * 1000} * 100 \qquad Equation ( 1 )$$

where free fatty acid content is expressed in terms of % (as oleic acid),
V is the volume of titrant used (mL),
N is the normality of the titrant (mol/L),
282 represents the molecular weight of oleic acid (g/mol), and
W is the sample weight (g).

The total carbohydrate content was determined using the phenol-sulfuric acid method (see X. Wang, S.-F. Liu, Z.-Y. Wang, T.-B. Hao, S. Balamurugan, D.-W. Li, Y. He, H.-Y. Li, C. S. K. Lin, A waste upcycling loop: Two-factor adaptive evolution of microalgae to increase polyunsaturated fatty acid production using food waste, Journal of Cleaner Production 331 (2022) 130018). Specifically, approximately 0.4 mg of freeze-dried samples were suspended in 1 mL of deionised water and treated with 1 mL of 5% phenol solution and 5 ml of sulfuric acid. After incubation at 25° C. for 30 min, the total carbohydrate content was analysed by detecting the absorbance at 483 nm wavelength using a microplate reader (SpectraMax M2, Molecular Devices, USA), corrected against a standard glucose calibration curve. Carbohydrate recovery in each phase (the crude lipids, hydrolysate, and remaining solids) is calculated as the percentage of the total carbohydrate content in that phase divided by the total carbohydrate content in the total FW.

Glucose concentration was determined through high-performance liquid chromatography (HPLC, Waters 2695, USA) equipped with an Aminex HPX-87H (Bio-Rad, USA) column and a refractive index (RI) detector (Waters 2414, USA) maintained at 35° C. The mobile phase was 5 mmol/L sulfuric acid, with a flow rate of 0.6 mL/min at 60° C.

The total protein content was determined using a bicinchoninic acid (BCA) protein assay kit (Beyotime, China), following the standard instructions provided by the supplier, with samples extracted through Western and IP cell lysates (Beyotime, China). Absorbance detection at 562 nm wavelength was performed using a microplate reader (SpectraMax M2, Molecular Devices, USA).

The TN content within the hydrolysate was determined using a total organic carbon analyser (Shimadzu TOC-L CSH/CPH, Japan) equipped with a total nitrogen unit (Shimadzu TNM-L, Japan). The standard curve was prepared using potassium nitrate.

FWLs were extracted from the crude lipids and remaining solid phases according to the same extraction procedure previously used for the gravimetrical determination of total lipid content, and as described earlier. Bio-based polyols were then synthesised through a process involving epoxidation and oxirane ring-opening of the FWLs. Epoxidation was performed in a rotating packed bed reactor equipped with a dephlegmator. The sample was poured into the reactor along with glacial acetic acid. The mixture was stirred at 480 rpm and heated. Dropwise addition of hydrogen peroxide started when the mixture reached a temperature of 40° C., and stopped for 30 min after the temperature increased to 60° C. The synthesis was considered to have started after the addition of hydrogen peroxide. The molar ratio of FWLs double bond, acetic acid, and peroxide was maintained at 0.5:1:1.5 to 1.5:1:0.5 (such as, 1:0.5:1.5), with 20 wt % ion exchange resin (AmberLite® IRC120 H) added. The resulting products were diluted with ethyl acetate and washed three times with warm distilled water to remove excess peroxide, acetic acid, water, and impurities. The organic phase was evaporated in a rotary vacuum evaporator to obtain epoxidised FWLs for further ring-opening.

Polyols were synthesised in a four-necked round-bottom flask equipped with a stirrer, thermocouple, nitrogen gas inlet, and Liebig condenser. Diethylene glycol (DEG) was poured into the flask and heated to 80-120° C. (such as 100° C.). Subsequently, 0.01-1%, (such as 0.25 wt %) (of epoxide) fluoroboric acid (HBF₄) was added as the catalyst. Epoxide was swiftly added through a dropping funnel while stirring at 200-800 rpm (such as 500 rpm), and the temperature was raised to 190° C. The synthesis process lasted 5-9 hours (such as 7 h), after which the FWL-based polyols were collected and appropriately stored.

These FWL-based polyols were then used in a typical formulation of PURF developed by the Latvian State Institute of Wood Chemistry (LSIWC) to produce cup test samples of the foamed material (see O. Gotkiewicz, M. Kirpluks, Z. Walterová, O. Kočková, S. Abbrent, P. Parcheta-Szwindowska, U. Cabulis, H. Beneš, Biobased Ultralow-Density Polyurethane Foams with Enhanced Recyclability, ACS Sustainable Chemistry & Engineering 12(4) (2024) 1605-1615). The PURF were prepared by adding polymeric 4,4′-methylene diphenyl isocyanate (pMDI) in appropriate stoichiometric ratios (20 wt % to 70 wt %) to other chemicals, including tris(1-chloro-2-propyl) phosphate (TCPP, flame retardant), blowing agents, and catalysts, as summarised in Table 1. The ingredients were mixed using a mechanical stirrer for 15 s at 2,000 rpm to form the PURF.

TABLE 1
Mass formulation for the development
of PURF using FWL-derived polyols.

| Materials | | Formulation |
|---|---|---|
| Polyol system | Lupranol ® 3422 | 30.00 |
| | FWL-derived polyols | 70.00 |
| Flame retardant | Tris(1-chloro-2-propyl) | 24.00 |
| | phosphate (TCPP) | |
| Blowing agents | Opteon ™ 1100 | 30.00 |
| | Water | 1.47 |
| Catalysts | PC CAT ® TKA 30 | 0.80 |
| | PC CAT ® NP10 | 0.80 |
| Surfactant | Niax ™ Silicone L-6915 | 1.50 |
| Isocyanate | Polymeric 4,4′-methylene | 177.27 |
| | diphenyl isocyanate (pMDI) | |

Epoxy value, acid value, hydroxyl value and iodine value were determined according to the ASTM D1652-11(2019), ASTM D1980-87(1998), ISO 4629-2:2016, and ISO 3961:2018 standards, respectively. Relative conversion to oxirane (RCO) is calculated using Equation (2) (see A. Abolins, M. Kirpluks, E. Vanags, A. Fridrihsone, U. Cabulis, Tall Oil Fatty Acid Epoxidation Using Homogenous and Heterogeneous Phase Catalysts, Journal of Polymers and the Environment 28(6) (2020) 1822-1831).

$$RCO = \frac{{OO}_{e}}{{OO}_{th}} \cdot 100 \% \qquad Equation ( 2 )$$

where 00ₑ is the experimentally determined content of oxirane oxygen calculated by Equation (3), and
00ₜₕ is the theoretical maximum oxirane content in 100 g of oil, which is determined according to Equation (4).

$${OO}_{e} = {A}_{o} \cdot EV \qquad Equation ( 3 )$$

where A_{O} is the atomic weight of oxygen, and EV is the epoxy value.

$${OO}_{th} = \frac{( \frac{{IV}_{0}}{2 {A}_{I}} ) \cdot {A}_{O}}{100 + ( \frac{{IV}_{0}}{2 {A}_{I}} ) \cdot {A}_{O}} \cdot 100 \% \qquad Equation ( 4 )$$

where IV₀ is the initial iodine value,
Aₗ is the atomic weight of iodine, and
A_{O} is the atomic weight of oxygen.

Relative ethylenic unsaturation (REU) is calculated using Equation (5) below.

$$REU = \frac{IV}{{IV}_{0}} \cdot 100 \% \qquad Equation ( 5 )$$

where IV is the iodine value of the FWL-derived epoxides, and
IV₀ is the initial iodine value.

Based on the calculated RCO and REU, the selectivity of the epoxidation reaction is determined using Equation (6).

$$Selectivity = \frac{RCO}{REU} \cdot 100 \% \qquad Equation ( 6 )$$

A Thermo Fisher Scientific Fourier-transform infrared (FTIR) spectrometer iS50 (Waltham, MA, USA) with a resolution of 4 cm⁻¹ (32 scans) was used to perform spectroscopic analysis in the infrared range of 4000-500 cm⁻¹. FTIR data were collected using the attenuated total reflectance (ATR) accessory with ZnSe and diamond crystals.

Gel permeation chromatography (GPC) analysis of samples (100 μL) was performed using an Agilent Infinity 1260 HPLC system with a degasser, an autosampler, an RI detector, and a multi-angle light scattering (MALS) detector (miniDAWN, Wyatt Technology). The analysis was performed using two GPC analytical columns (PLgel Mixed-E, 3 uL, 300 mm×7.5 mm) connected in line. The flow rate was 1 mL/min, and the RI detector temperature was 35° C. The polystyrene calibration graph was obtained by preparing polystyrene standard solutions in tetrahydrofuran (THF) at a mass concentration of 2 mg/mL and analysing them with a GPC/size exclusion chromatography (SEC) instrument. The molecular weights of polystyrene standard substances were 500, 850, 1000, 2500, 5000, 9000, 17,500, and 20,000 Da.

Sample derivatisation was performed before the gas chromatography (GC) analysis. Approximately 20 mg of samples were mixed with 50 μL of methanol and 200 μL of 12.5 w/v % boron trifluoride-methanol solution. After tightly capping the vials, they were heated for 30 min at 70° C. Subsequently, pure water (100 μL) was added. After tightly capping the vials again, they were vigorously shaken. Next, 150 μL of dichloromethane was added, and fatty acid methyl esters were extracted into the dichloromethane layer. The organic layer was transferred to another vial, and 1 μL was injected into a Thermo Scientific TRACE 1300 gas chromatograph equipped with a Thermo Scientific ISQ quadrupole mass detector. A Thermo Scientific TG-5 MS (30 m×0.25 mm×0.25 μm) column was used for the analysis, with helium serving as the carrier gas at a flow rate of 1.20 mL/min. The injection temperature was 250° C. in split mode (500). The oven temperature was programmed to be isothermally held at 150° C. for 5 min, then increased at 10° C./min and held for 1 min, before being finally ramped at 2° C./min to 300° C. and held for 15 min. The total analysis time was 60 min. The transition line temperature of the mass detector was 250° C., and the ion source temperature was 200° C. The mass range was 45-700 Da.

The apparent density of the obtained PURF was assessed according to the ISO 845:2006 standard. The foaming parameters, start time, and rise time were measured using the foam qualification system FOAMAT® 285 (Messtechnik GmbH, Germany). The thermal conductivity coefficient (λ) was obtained using a FOX 200 (TA Instruments, New Castle, USA), according to the ISO 8301:1991 standard, at an average temperature of 10° C. (cold plate: 0° C., and hot plate: +20° C., sample dimensions: 200 mm×200 mm×30 mm). An Anton Paar rheometer MCR 92 (Graz, Austria) with a cone-plate measurement system was used to test the apparent viscosity at a shear rate of 50 s⁻¹ and temperature of 25° C. The compression strength of the obtained PURF was determined in parallel and perpendicular to the foaming direction in accordance with ISO 844:2021. At least triplicate specimens were tested in each direction. The specimens are in a dimension of 20 mm×20 mm×20 mm. Compressive strength was determined at a constant speed of 10%/min until the deformation reached 10%. The thermal stability of the PURF was determined by thermogravimetric analysis (TGA) using Discovery SDT 650 (TA Instruments). The measurements were conducted from 30 to 800° C. at a heating rate of 10° C./min with a constant nitrogen flow.

All FW biorefinery models were simulated using the SuperPro Designer version 13 software (Intelligen, USA). All models were assumed to have a 20-year (y) lifetime, including 2 y for construction and startup. The operation was assumed to be in batch mode, with an annual operation time of 7920 h (approximately 90% on-stream). Mass and energy balance and relevant economic evaluations were performed using SuperPro Designer version 13 and Microsoft Excel. The parameters for economic evaluations were set based on the literature and default settings of SuperPro Designer version 13 (see H. Wang, C.-W. Tsang, M. H. To, G. Kaur, S. L. K. W. Roelants, C. V. Stevens, W. Soetaert, C. S. K. Lin, Techno-economic evaluation of a biorefinery applying food waste for sophorolipid production-A case study for Hong Kong, Bioresource Technology 303 (2020) 122852, and K. S. Woon, I. M. C. Lo, An integrated life cycle costing and human health impact analysis of municipal solid waste management options in Hong Kong using modified eco-efficiency indicator, Resources, Conservation and Recycling 107 (2016) 104-114). The detailed settings are outlined in Table 2.

TABLE 2
Economic evaluation parameters, adopted from the literature
and default settings of SuperPro Designer v13

| Items | | Assumptions |
|---|---|---|
| Year of Analysis | 2024 | |
| Project Lifetime | 20 | y |
| Construction Period | 20 | months |
| Startup Period | 4 | months |
| Inflation | 4 | % |
| NPV Interest | 7 | % |
| Depreciation (10-y straight line) | 5 | % DFC |
| Income Taxes | 16.5 | % |
| Annual Operation Time | 7920 | h |

Equipment Purchase Cost (PC) = Major Equipment Purchase
Cost + Unlisted Equipment Purchase Cost

| | | |
|---|---|---|
| Unlisted Equipment Purchase Cost | 0.20 | × PC |

Direct Fixed Capital (DFC) = DC + IC + Other Cost
Direct Cost (DC)

| Installation (Major Equipment) | equipment-specific factor | |
|---|---|---|
| | (0.3 to 0.5) multiplied by | |
| | the equipment purchase cost | |
| Installation (Unlisted Equipment) | 0.10 | × PC |
| Piping | 0.35 | × PC |
| Instrumentation | 0.40 | × PC |
| Insulation | 0.03 | × PC |
| Electrical Facilities | 0.10 | × PC |
| Buildings | 0.45 | × PC |
| Yard Improvement | 0.15 | × PC |
| Auxiliary Facilities | 0.40 | × PC |

Indirect Cost (IC)

| | | |
|---|---|---|
| Engineering | 0.25 | × DC |
| Construction | 0.35 | × DC |

Other Cost

| | | |
|---|---|---|
| Contractor's Fee | 0.05 | × (DC + IC) |
| Contingency | 0.10 | × (DC + IC) |

Total Capital Investment (TCI) = DFC + Working
Capital + Startup and Validation

| | | |
|---|---|---|
| Working Capital | 30 | Days of operation |
| Startup and Validation | 5 | % DFC |

Annual Operating Cost (AOC) = Materials Cost + FDC + Total
Labour Cost (TLC) + Lab/QA/QC + Utilities + Waste Treatment
Facility-Dependent Cost (FDC)

| Maintenance | 0.10 | × PC |
|---|---|---|
| Depreciation | Use contribution from each | |
| | equipment's undepreciated | |
| | purchase cost | |
| Miscellaneous Costs | 8 | % DFC |
| Lab/QA/QC | 15 | % TLC |

The location of the modelled plant was assumed to be in mainland China, and the equipment costs were adjusted by building equipment-specific user-defined cost models using Equation (7).

$$C = {C}_{0} * {( \frac{Q}{{Q}_{0}} )}^{α} \qquad Equation ( 7 )$$

where (C, Q) represents a pair of targeted equipment cost and capacity;
(C₀, Q₀) denotes a pair of reference equipment cost and capacity; and
α is an equipment-specific exponent.

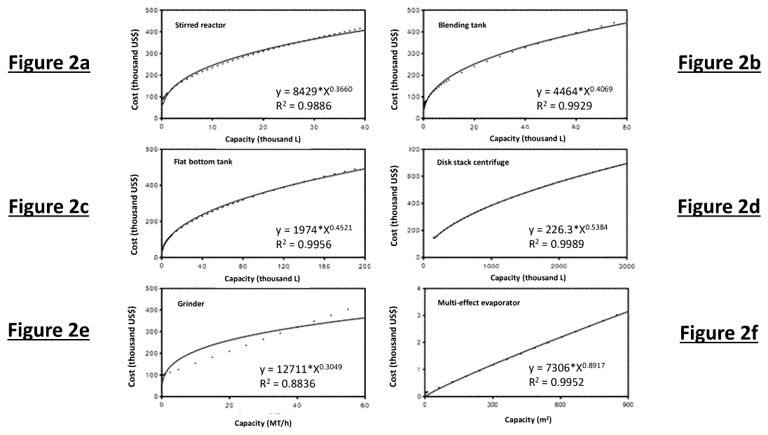

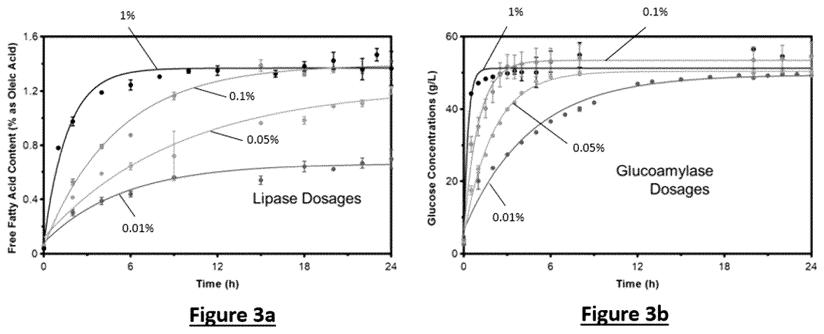

Details of the user-defined cost models can be found in Table 3 and FIGS. 2a to 2f. The costs of raw materials, utilities, consumables, and labour, along with the revenue selling price, are summarised in Table 4.

TABLE 3
User-defined cost models for major equipment types used in this study.

| | | Capacity | | | | | |
|---|---|---|---|---|---|---|---|
| Equipment | Reference | Low | High | | Reference | Base | Base |
| Type | Unit | End | End | α value* | Year | Capacity | Cost |
| Stirred reactor | L | 250 | 40,000 | 0.3660 | 2022 | 13,000 | 30,000 |
| Blending tank | L | 250 | 80,000 | 0.4069 | 2023 | 10,000 | 18,000 |
| Flat-bottom | L | 250 | 200,000 | 0.4521 | 2023 | 10,000 | 1,3000 |
| tank | | | | | | | |
| Disc stack | L/h | 150,000 | 3,000,000 | 0.5384 | 2022 | 150,000 | 25,000 |
| centrifuge | | | | | | | |
| Grinder | kg/h | 125 | 60,000 | 0.3049 | 2019 | 6,000 | 17,000 |
| Multi-effect | m² | 3 | 900 | 0.8917 | 2019 | 30 | 135,000 |
| evaporator | | | | | | | |

*The α value for each equipment type was obtained through non-linear (power function) fitting performed using GraphPad Prism with data extracted from SuperPro Designer v13 built-in cost models. Detailed fitting curves can be found in FIGS. 2a to 2f.

TABLE 4
Materials, utilities, consumables, and labour costs.

| | | |
|---|---|---|
| | Unit | |
| Items | Cost | Unit |

Raw Materials

| | | |
|---|---|---|
| Food waste | 40 | $/MT |
| Glucoamylase | 4,000 | $/MT |
| Lipase | 6,000 | $/MT |
| Hexane | 1,460 | $/MT |
| Epoxidation catalyst | 1,200 | $/MT |
| Acetic acid | 440 | $/MT |
| Hydrogen peroxide | 126 | $/MT |
| (35% in methanol) | | |
| DEG | 829 | $/MT |
| HBF₄ | 1,418 | $/MT |
| pMDI | 2,500 | $/MT |
| TCPP | 1,400 | $/MT |
| Other chemicals for PURF* | 2,000 | $/MT |
| Water | 0.49 | $/m³ |

Utilities

| | | |
|---|---|---|
| Std power (Electricity) | 0.03 | $/kWh |
| Steam | 12 | $/MT |
| Steam (High pressure) | 14 | $/MT |
| Cooling water | 0.03 | $/MT |
| Chilled water | 0.4 | $/MT |
| Hot water | 0.4 | $/MT |

Labour

| | | |
|---|---|---|
| Operator | 21 | $/h |

Waste Treatment

| | | |
|---|---|---|
| Wastewater | 0.20 | $/m³ |

Revenue Selling Prices

| | | |
|---|---|---|
| PURF | 2.5 | $/kg |
| Animal feed | 0.065 | $/kg |
| Glucose | 620 | $/MT |

*Other chemicals for preparing PURF included Lupranol ® 3422, Opteon ™ 1100, water, PC CAT ® TKA 30, PC CAT ® NP10, and Niax ™ Silicone L-6915, referred to in Table 1.

While it is understood that efficient logistics is a prerequisite for the successful utilisation of FW as a generic feedstock in waste-based biorefinery, FW was only assumed to be delivered to the modelled factory at a price covering transportation expenses.

In terms of process economics, the total capital investment (TCI) is the sum of the direct fixed capital (DFC), working capital, and startup and validation costs. The DFC consisted of direct, indirect, and other costs, estimated primarily from the equipment purchase cost (PC). The annual operation cost (AOC) consists of the material cost, facility-dependent cost (FDC), total labour cost, laboratory/quality assurance/quality control (lab/QA/QC) cost, utilities cost, and waste treatment cost. Specifically, the FDC considered equipment maintenance costs, depreciation, and miscellaneous costs. Revenues included PU rigid foams, animal feed, and glucose-containing hydrolysate. The use of protein-containing residues as animal feed was justified by our Hong Kong Patent No. HK 1,236,722.

Profitability analysis was performed by determining net present value (NPV), return on investment (ROI), payback time, and internal rate of return (IRR). Calculations were performed using SuperPro Designer v13 with built-in economic evaluation equations. Sensitivity analysis was performed considering the variables' fluctuation during the economic analysis. The rationales for the chosen minima/maxima for single-point sensitivity analysis are summarised in Table 5.

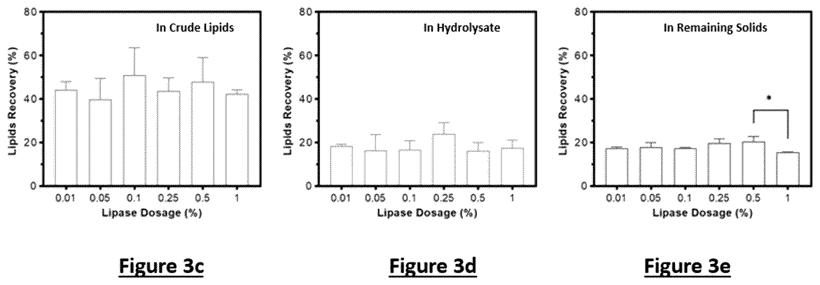

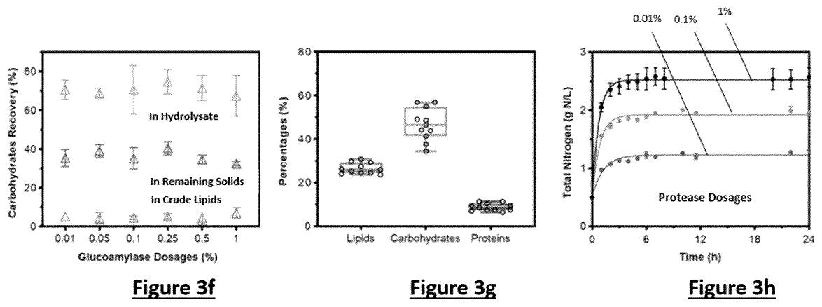

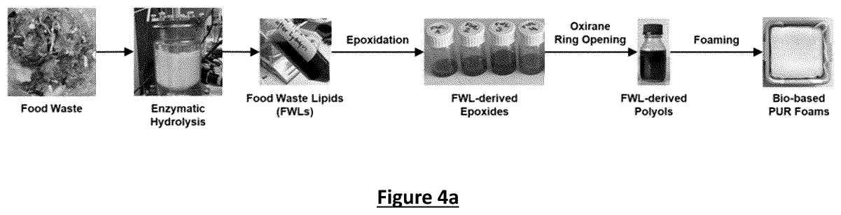

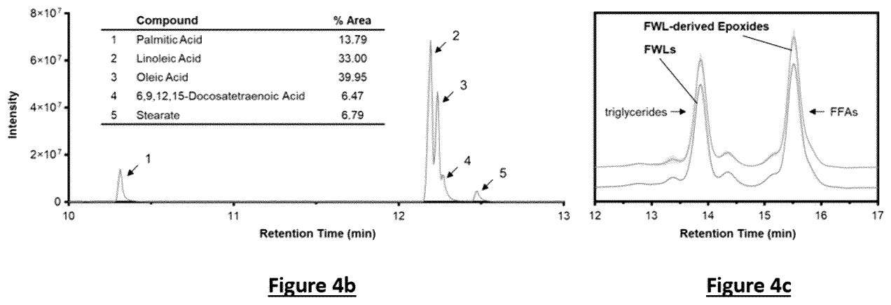

TABLE 5
Rationales for the chosen minima/maxima
for single-point sensitivity analysis.

| Sensitivity Analysis Parameter | |
|---|---|
| (low:base:high) | Rationale of Minima/Maxima |
| Food Waste Cost | Reflect changes in the feedstock for |
| (32:40:48 US$/MT) | the proposed biorefinery scheme. |
| Lipid Content in Food Waste | Reflect the error bar of lipids within |
| (5.432:6.79:8.148% of wet FW) | food waste, as shown in FIG. 3g. |
| Material Purchase Cost | Refer to material cost in Table 4. |
| (80%:100%:120%) | Reflect market fluctuations. |
| PURF Selling Price | Reflect market fluctuations. |
| (2:2.5:3 US$/kg) | |
| Equipment Purchase Cost | Refer to the equipment base cost in |
| (80%:100%:120%) | Table 3. Reflect change in total |
| | capital investment. |

Enzyme kinetics were analysed using the one-phase association non-linear regression method in GraphPad Prism. Statistical significance analysis was also performed using GraphPad Prism. Moreover, GraphPad Prism was used to construct non-linear (power function) fitting curves for user-defined equipment cost models.

Before further valorisation, the FW was first enzymatically hydrolysed to release its nutrients. All results relevant to FW hydrolysis are shown in FIGS. 3a to 3h. To explore the recovery potential of FW, the composition of FW obtained from a Chinese restaurant was determined. As shown in FIG. 3g, the FW contained 26.50±2.48%, 46.77±7.49%, and 8.77±1.76% of lipids, carbohydrates, and proteins, respectively, on a dry-weight basis. The FW exhibited a notable lipid content, which favoured its subsequent conversion into bio-based polyols and PURF. In addition, the FW contained a considerable amount of carbohydrates, which could be further valorised into various value-added products through enzymatic hydrolysis and biorefinery processes. The percentage of protein content was relatively low, consistent with findings from another study on FW from a Chinese restaurant (see J.-H. Mou, Z.-H. Qin, Y.-F. Yang, S.-F. Liu, W. Yan, L. Zheng, Y.-H. Miao, H.-Y. Li, P. Fickers, C. S. K. Lin, Navigating practical applications of food waste valorisation based on the effects of food waste origins and storage conditions, Chemical Engineering Journal 468 (2023) 143625).

Typically, enzymes (i.e., glucoamylase, protease, and lipase) are overdosed up to 1 v/w or w/w % when treating FW to ensure effective hydrolysis. However, overdosing may increase enzyme costs and reduce cost-effectiveness if the same ratios of enzyme dosages are adopted in TEA studies. Various enzyme dosages (0.01 to 1 v/w or w/w %) were thus applied to investigate the optimum dosages to ensure the cost-effectiveness of the enzymes.

To examine the lipase performance, the FFA content in the hydrolysate was determined during FW hydrolysis, as lipase hydrolyses lipids into glycerol and FFAs. FIG. 3a shows profiles of FFA content under various lipase dosages, along with the respective one-phase association non-linear fitting curves. In the initial stages (i.e., 0 to 8 h) of hydrolysis, increased dosages of lipase led to a higher concentration of FFAs. However, after 24 h, the final concentrations of FFAs were similar at dosages of 0.1% and 1%, indicating comparable hydrolytic performance between these two groups. The groups with lower lipase dosages (0.05% and 0.01%) failed to reach the same final concentrations of FFAs as those with higher dosages.

These results were consistent with those of prior studies: under a certain threshold, increased lipase dosage led to a significant increase in hydrolysis yield. However, beyond this threshold, a further increase in lipase dosage did not significantly increase the FFA concentration as the reaction had reached equilibrium. Lipase dosages of 0.01%, 0.5%, and 0.1% also indicated a possibility of an inhibitory effect toward the lipase. For instance, after 12 h of hydrolysis, no significant increase of FFAs was observed in the group of 0.01% lipase, indicating a loss of lipase activity, potentially attributable to unfavourable pH conditions. With no alteration of pH during FW hydrolysis, the pH of the hydrolysate was usually 4 to 5, but the optimum pH for the lipase used in the embodiment of the present invention was 7 to 9. Consequently, the lipase activity deteriorated owing to the unfavourable pH condition.

Increased dosages of glucoamylase in the initial 6 h led to an elevated hydrolysis rate of starch into glucose. However, across all glucoamylase dosages (0.01% to 1%), all groups reached a similar plateau after 24 h, as shown in FIG. 3b. This outcome demonstrated the efficiency of glucoamylase in hydrolysing α-1,4 and α-1,6-glycosidic bonds of starch, dextrin, glycogen, and other similar compounds, starting from the non-reducing ends. As carbohydrates were the most abundant nutrients within the FW, the hydrolysis conditions (e.g., temperature and pH) were favourable for glucoamylase. FIG. 3b also illustrates the trade-off between enzyme dosage and hydrolysis time. With a hydrolysis duration of 12 h, 0.05% glucoamylase was sufficient for FW hydrolysis to reach equilibrium. If the duration was extended to 24 h, 0.01% glucoamylase was sufficient. Enzyme dosage has been noted to influence the cost-effectiveness of biorefinery schemes based on lignocellulose biomass. Similarly, the influence of enzyme dosages on the profitability of the proposed FW biorefinery will be discussed further below.

The hydrolysis of proteins within the FW was monitored by determining the TN in the hydrolysate (FIG. 3h). The protease activity was inhibited from the beginning of hydrolysis regardless of the dosages. Improper conditions for protease likely resulted in this immediate loss of activity. In this embodiment, the temperature was set at 55° C., and the unregulated pH was approximately 4 to 5 during the one-pot hydrolysis process. However, the optimum settings for protease include a temperature of 40 to 50° C. and a pH value of 6.5 to 7.5. Consequently, protease lost its function due to the unfavourable environment. Considering the low protein content in the FW (FIG. 3g) and the simplicity of one-pot hydrolysis, it was still rational to design the experiment to primarily support the hydrolysis of carbohydrates and lipids, which were more abundant. However, the addition of protease requires further consideration.

In addition to analysing the component profiles, the influence of different enzyme dosages on the recovery of nutrients from FW was also examined. After enzymatic hydrolysis and centrifugation, the hydrolysed FW slurry was separated into crude lipids, the hydrolysate, and the remaining solids. FIGS. 3c to 3e illustrate the distributions of the total lipids into the respective phases, and FIG. 3f summarises the distribution of total carbohydrates. In most of the cases, the enzyme dosages did not significantly influence the distribution and recovery of lipids and carbohydrates. After hydrolysis, lipids mainly flowed into the crude lipid phase (44.95% on average, as shown in FIGS. 3c to 3e), whereas carbohydrates primarily ended up in the hydrolysate (70.70% on average, as shown in FIG. 3f), given that the majority of the carbohydrates were hydrolysed into glucose, which is highly soluble in water. Based on these findings and the substantial volume of hydrolysate, the FWLs were extracted from crude lipids and remaining solids for further conversion into PURF.

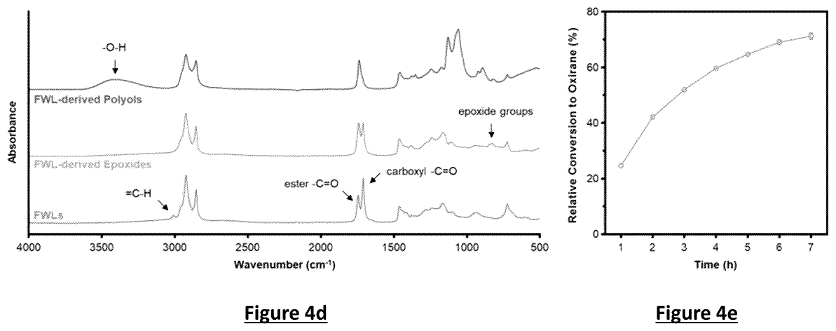

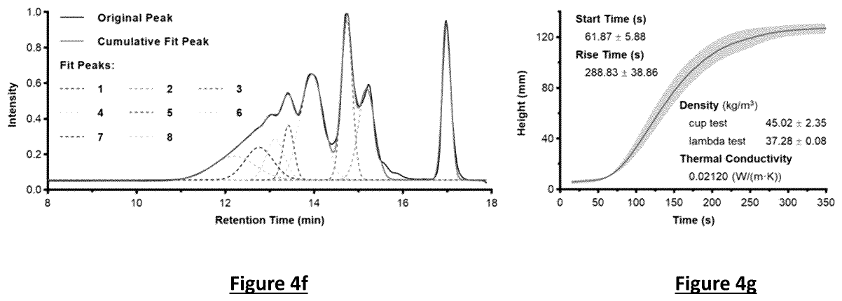

After FW hydrolysis, the extracted FWLs were synthesised into bio-based polyols through epoxidation and oxirane ring-opening and then transformed to PURF. The overall experimental scheme is presented in FIG. 4a. Table 6 and FIGS. 4b to 4g summarise the characteristics of FWLs, epoxides, and polyols.

TABLE 6
Characteristics of FWLs, FWL-derived
epoxides, and FWL-derived polyols.

| | | FWL-derived | FWL-derived |
|---|---|---|---|
| | FWLs | Epoxides | Polyols |
| Iodine value | 105.76 ± 0.41 | 16.34 ± 1.67 | N.A. |
| (g I₂/100 g) | | | |
| Acid value | 103.40 ± 1.38 | 96.41 ± 0.69 | 8.48 ± 0.12 |
| (mg KOH/g) | | | |
| Hydroxyl value | N.D. | N.D. | 366.63 ± 1.13 |
| (mg KOH/g) | | | |
| Viscosity | 200.35 ± 3.72 | 416.19 ± 2.08 | 546.65 ± 6.53 |
| (mPa · s) | | | |
| Epoxy value | N.A. | 0.28 ± 0.00 | N.A. |
| (mol/100 g) | | | |
| RCO (%) | N.A. | 71 ± 1 | N.A. |
| REU (%) | N.A. | 15.45 ± 1.64 | N.A. |
| Selectivity | N.A. | 0.84 ± 0.10 | N.A. |

Note:
N.D. represents not detectable; N.A. represents not applicable.

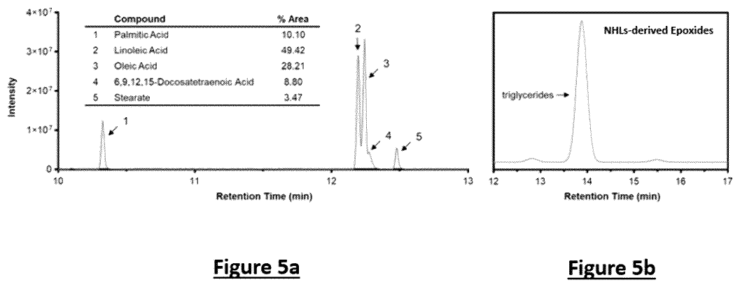

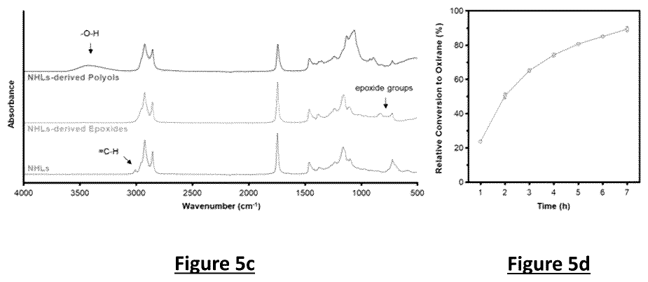

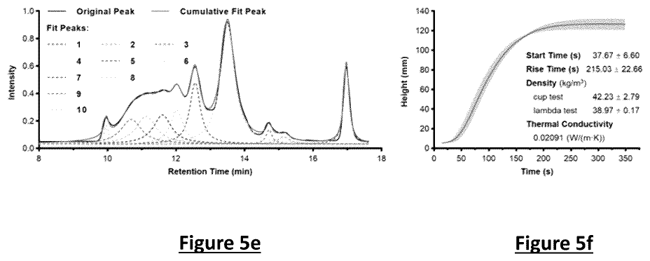

In addition to the FWLs that were hydrolysed, another set of non-hydrolysed lipids (NHLs, directly extracted from FW without hydrolysis) was assessed using the same synthesis procedure for comparative analyses. The results of NHLs are summarised in Table 7 and FIGS. 5a to 5f.

TABLE 7
Characteristics of the NHLs, NHL-derived
epoxides, and NHL-derived polyols.

| | | NHL-derived | NHL-derived |
|---|---|---|---|
| | NHLs | Epoxides | Polyols |
| Iodine value | 116.18 ± 0.50 | 9.33 ± 0.78 | N.A. |
| (g I₂/100 g) | | | |
| Acid value | 3.14 ± 0.49 | 6.21 ± 0.54 | 2.62 ± 0.09 |
| (mg KOH/g) | | | |
| Hydroxyl value | 3.14 ± 0.03 | N.D. | 279.37 ± 4.82 |
| (mg KOH/g) | | | |
| Viscosity | 71.69 ± 0.29 | 305.00 ± 0.77 | 7096.67 ± 324.85 |
| (mPa · s) | | | |
| Epoxy value | N.A. | 0.381 ± 0.006 | N.A. |
| (mol/100 g) | | | |
| RCO (%) | N.A. | 89 ± 2 | N.A. |
| REU (%) | N.A. | 8.03 ± 0.71 | N.A. |
| Selectivity | N.A. | 0.97 ± 0.10 | N.A. |

Note:
N.D. represents not detectable; N.A. represents not applicable; RCO represents relative conversion to oxirane; REU represents relative ethylenic unsaturation.

Before synthesis, FWLs were characterised to clarify the composition and structure of the raw materials compared with the NHLs. The iodine value of FWLs was 105.76±0.41 g I₂/100 g, indicating a considerable degree of unsaturation, similar to our previous investigation. The NHLs exhibited a higher iodine value (116.18±0.50 g I₂/100 g; Table 7), suggesting a larger number of double bonds in their structures. Nonetheless, the iodine values of both FWLs and NHLs were similar to typical iodine values of edible oils, such as canola, corn, sunflower, or soybean oils. The FWLs exhibited a significantly higher acid value (103.40±1.38 mg KOH/g) compared with the NHLs (3.14±0.49 mg KOH/g), indicating that triglycerides were hydrolysed into FFAs during the hydrolysis of FW, as illustrated in FIG. 3a. The initial viscosity values of FWLs and NHLs were 200.35±3.72 and 71.69±0.29 mPa·s, respectively. Consistent with other natural oils, except castor oil, FWLs lacked hydroxyl groups, necessitating further chemical modifications before use in PURF production. GC-MS analysis revealed that oleic acid (39.95%) and linoleic acid (33.00%) were the most abundant fatty acids among FWLs (FIG. 4b). Similarly, as shown in FIG. 5a, linoleic acid (49.42%) and oleic acid (28.21%) were still the most abundant fatty acids in NHLs. However, the contents of linoleic acid and 6,9,12,15-docosatetraenoic acid were higher in the NHLs, consistent with their higher iodine value than those of FWLs. The GPC chromatograms of FWLs and NHLs are shown in FIG. 4c and FIG. 5b, respectively. The results suggested that NHLs had a higher average molecular weight of 891.1 g/mol (triglycerides and diglycerides) and a lower polydispersity of 1.02, consistent with their non-hydrolysed nature. In comparison, the FWLs sample was a mixture of fatty acid triglycerides and FFAs with an average molecular weight of 582.7 g/mol and a polydispersity of 1.31.

Epoxidation was first applied to FWLs to convert the inherited double bonds into oxiranes using the peracetic acid generated in situ through the reaction of hydrogen peroxide and acetic acid in the presence of an acidic catalyst. Functional groups were characterised by the FTIR spectra (FIG. 4d) absorption bands. For synthesised bio-polyols from FWLs, typical symmetric and asymmetric stretching peaks of the —CH₂— group were observed at ˜2,923 and 2,853 cm⁻¹. Furthermore, FWLs demonstrated the carbonyl ester group C═O stretching vibration at ˜1,742 cm⁻¹. In FTIR results, the absorption band of ═C—H stretching vibration of the alkene groups observed in the FWLs spectra at 3,009 cm⁻¹ disappeared in FWL-derived epoxides. Moreover, the formation of epoxide groups in FWLs was confirmed by the occurrence of an epoxy ring absorption band at 823 cm⁻¹. The FWLs had two carboxyl group C═O absorption bands of ester at ˜1,737 cm⁻¹ and acid at ˜1,707 cm⁻¹. Interestingly, for the FWLs, the carboxyl group C═O ester peak intensity increased after the epoxidation process, indicating the occurrence of side reactions, likely attributable to the abundance of FFAs within FWLs. For all synthesised bio-polyols, a broad absorption peak was identified between 3,600 and 3,100 cm⁻¹ as characteristic stretching vibrations of the OH group. As shown in Table 6, the acid value of FWLs slightly decreased after epoxidation, likely due to the formation of esters. In contrast, the acid value of the NHLs slightly increased after epoxidation (Table 7), indicating the potential hydrolysis of triglycerides. In addition, the epoxy values for FWLs and NHLs were 0.28±0.00 and 0.38±0.01 mol/100 g, respectively. The relative conversion to oxirane was 71±1% and 89±2% for FWLs and NHLs, respectively. A detailed profile of the relative conversion to oxirane is presented in FIG. 4e and FIG. 5d. The epoxy value and relative conversion to oxirane were slightly higher for NHLs than those for FWLs. However, further analyses demonstrated the necessity of hydrolysis for improving the quality of generated polyols and PURF. The higher epoxy value of NHLs-derived epoxides was attributable to their higher initial iodine value compared with FWLs. Moreover, the free carboxylic groups in FWLs contributed to the decrease in the final epoxy value and relative conversion to epoxide, as they promoted epoxy ring-opening with various reagents present in the synthesis medium, such as water and/or carboxylic groups of acetic acid or FWLs.

After the successful epoxidation of FWLs, the oxirane rings were opened using DEG to introduce the hydroxyl functional groups. The hydroxyl value in FWL-derived polyols (366.63±1.13 mg KOH/g), as indicated in Table 6, confirmed the stepwise synthesis of bio-based polyols from FWLs. The relevant FTIR spectrum (FIG. 4d) also supported this conclusion, given the peak of hydroxyl groups observed at approximately 3,350 cm⁻¹. Although previous results suggested that the NHLs underwent better epoxidation than FWLs, the hydroxyl value of NHL-derived polyols (279.37±4.82 mg KOH/g; Table 7) did not further increase. The GPC chromatograms of FWLs and NHLs (FIG. 4f and FIG. 5e, respectively) offered potential explanations. The epoxidised NHLs had an average molecular weight of 3,232.2 g/mol and a polydispersity of 2.02. In contrast, the epoxidised FWLs had an average molecular weight of 1,269.7 g/mol and a polydispersity of 1.48. The triglyceride structure of epoxidised NHLs contributed to the formation of large oligomerisation products during the synthesis of bio-based polyols, which decreased the OH value of the polyol. Furthermore, the viscosity of the bio-based polyols obtained from FWLs was considerably lower than that from NHLs (546.65±6.53 and 7,096.67±324.85 mPa·s, respectively). Because the hydroxyl value and viscosity are the main factors characterising the quality of polyols, the oligomerisation of NHLs is undesirable as it complicates the production of PURF.

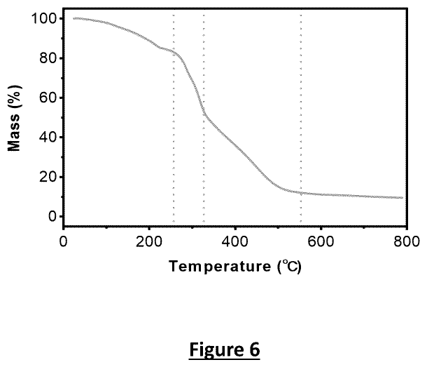

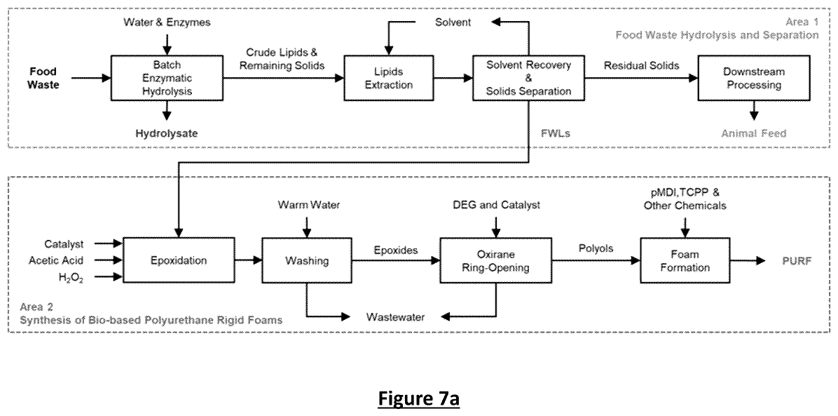

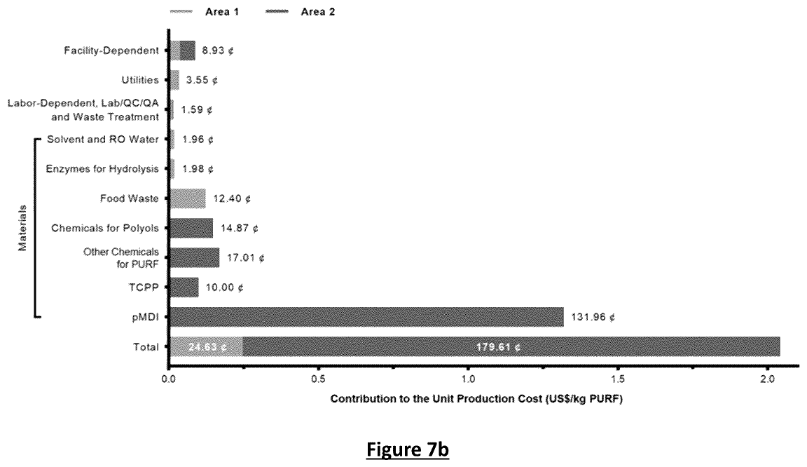

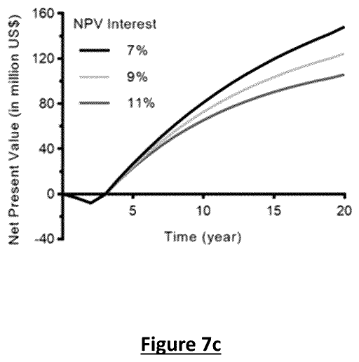

Both bio-based polyols obtained were suitable for developing PURF, as indicated by the foam rise curves and characteristics (FIG. 4g and FIG. 5f). The apparent density of the developed PURF was close to 40 kg/m3, suitable for industrial applications in civil engineering. The thermal conductivity of the FWL-derived PURF was 21.20 mW/(m·K), indicating their suitability as insulation materials, given the industrial standard of 22 mW/(m·K). Notably, compared with conventional insulation materials, such as rock wool (33-40 mW/(m·K)), expanded polystyrene (29-41 mW/(m·K)), extruded polystyrene (32-37 mW/(m·K)), and fossil-based PU (22-35 mW/(m·K)), the FWL-derived bio-based PURF exhibited excellent superiority. Moreover, the mechanical properties of the obtained foams were also satisfying. The uniaxial compression tests showed that the compressive strength of the FWL-derived PURF is 0.22±0.03 MPa (in parallel direction) and 0.12±0.01 MPa (in perpendicular direction), which is similar to other bio-based PURF. The TGA results of the FWL-derived PURF are displayed in FIG. 6. The thermal stability of the FWL-derived PURF is also comparable to other PURF developed from bio-based polyol. Due to the complex composition of the foam system, the thermal degradation of the FWL-derived PURF can roughly be separated into four stages. TCPP (decomposition temperature is 244° C.) and other components with lower thermal stability first degraded until approximately 250° C. The second step of the thermal degradation, ranging from 250 to 327° C., may involve the degradation of the rigid fraction of the foam, including isocyanates, urethanes, isocyanurate groups, amines and polyols. The soft fractions degraded until around 550° C., such as petrochemical polyol (Lupranol® 3422) and polyethylene glycol parts of bio-based polyol. A summary of the comparison between FWL-derived PURF and other bio-based PURF is presented in Table 8.

TABLE 8
Comparison of properties between FWL-derived PURF in this invention
and PURF derived from other sustainable feedstocks.

| | | Sust. Mat. | Apparent | Thermal | Compressive |
|---|---|---|---|---|---|
| | Sustainable | Cont.* | Density | Conductivity | Strength |
| Samples | Feedstock | (%) | (kg/m³) | (mW/(m · K)) | (MPa) |
| FWL-derived PURF | Food waste | 20.8 | 37.3 | 21.2 | 0.22 |
| Rigid PU Foam F0 | N.A. | N.A. | 37.4 | 25.5 | 0.21 |
| ETOFA_TMP-85 | Tall oil | 19.4 | 37.7 | 20.5 | 0.32 |
| c-pentane-9 | | | | | |
| RO/PET_150 | Rapeseed oil | ~12.5 | 39.1 | 20.7 | 0.35 |
| | and Waste PET | | | | |
| PU-1 | Castor oil | N.A. | 34 | 19 | 0.24 |
| EtOH50 | Microalgae oil | 18.3 | 30 | 24.5 | 0.27 |
| RS-50% | Agricultural | 23.3 | 18.7 | 41 | 0.26 |
| | rice straw | | | | |
| PUF-bio-3/7 | Soybean oil | 13.0 | 37.0 | 20.5 | 0.22 |
| 50% RPCP | Coconut oil and | 21.7 | 43.9 | 22.8 | 0.35 |
| | waste polycarbonate | | | | |

*‘Sust. Mat. Cont.’ refers to sustainable material content, which is calculated as the percentage of materials obtained from the sustainable feedstock in the total mass of the PURF.

The sustainable material content, also referred to as the sustainability index, gives a measure of the sustainability of the examined system (i.e. the degree of sustainability of the produced PURF). It is calculated as the weight percentage of mass derived from sustainable components with respect to the total mass of the PURF. It can be concluded that, while exhibiting similar apparent density, thermal conductivity, and compressive strength, FWL-derived PURF also has a relatively higher sustainable material content (20.8%), favoured by the pursuit of sustainable plastics.

After demonstrating the conversion from FW into PURF, as discussed earlier, a base case simulation model was developed to assess the economic potential through TEA. As various TEA studies have already attempted to examine the economic performance of valorising FW hydrolysate into various value-added products, this invention focuses on the process of PURF production. Thus, FW hydrolysate was considered a by-product with an assigned price based on the glucose content. In addition, to facilitate comparison with other TEA studies on FW biorefineries, the FW processing capacity in the base case was set as 10 MT/h.

FIG. 7a shows an overview of the major processes in the base case, divided into two areas. The configurations of unit procedures within the models were briefly described here. Area 1 covered FW hydrolysis and separation. First, the size of the FW was reduced by grinding, and it was mixed with water to achieve a solid-to-liquid ratio of 30 w/v %. As discussed earlier, the cost-effective dosages of lipase and glucoamylase were considered to be 0.1 w/v % and 0.01 v/v %, respectively; therefore, these values were applied in the base case. Protease was not applied in the base case owing to its poor hydrolytic performance. An additional case (high enzyme dosages of 1 w/v or v/v %) was established to assess the associated economic impact of the enzymes. Hydrolysis was performed at 55° C. for 24 h for each batch in a stirred reactor. The hydrolysed slurry was then centrifuged into three phases. As mentioned, the hydrolysate (aquatic phase) was directly sold as a by-product. Simultaneously, crude lipids (oil phase) were combined with the remaining solids (solid phase) and sent for solvent extraction. The lipid-rich organic phase was subjected to an evaporator to concentrate the lipid stream and recover the solvent at a recovery rate of 99.8%. The residual solids were sent to a protein extraction unit at a 50% split ratio to recover proteins, which could then be sold as animal feed. Moreover, the obtained FWLs were sent to Area 2 to synthesise bio-based polyols and PURF. In Area 2, epoxidation was modelled in a reactor. After being charged with FWLs and the epoxidation catalyst, the reactor was heated and agitated while glacial acetic acid was added. When the temperature reached 40° C., hydrogen peroxide was added, while the temperature was further raised to 60° C. for 30 min. The mass ratio for the FWLs, catalyst, acetic acid, and hydrogen peroxide was 200:40:25.15:127.09. The resulting products were then washed with warm (40° C.) water and separated in a centrifuge. The epoxides (oil phase) were collected in a feed tank for further operations. Oxirane ring-opening was simulated in a continuously stirred reactor purged with nitrogen gas. DEG was first added into the reactor and heated to 100° C., and HBF4 was added as the catalyst. Subsequently, the epoxides were transferred into the reactor while the temperature was raised to 190° C. The mass ratio for the FWL-derived epoxides, DEG, and HBF4 was 100:71.42:0.23. This unit procedure also included a distillation operation to separate the desired products, and the distillate was collected for waste treatment. The obtained bio-based polyols were finally mixed with all other reactants to form PURF.

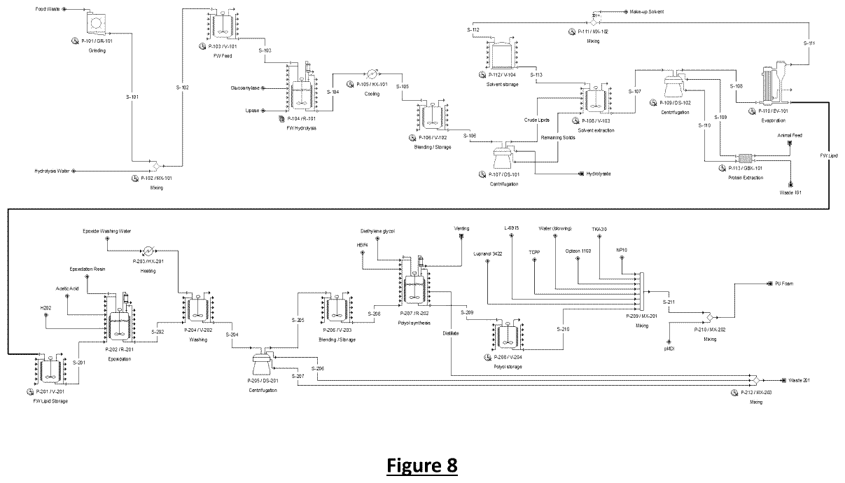

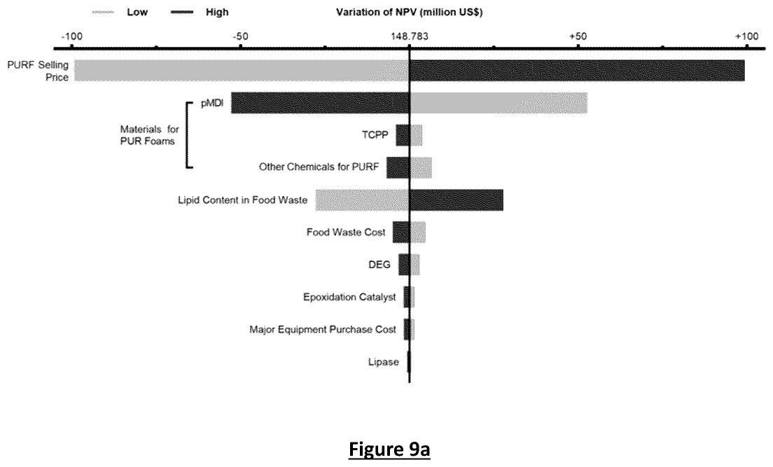

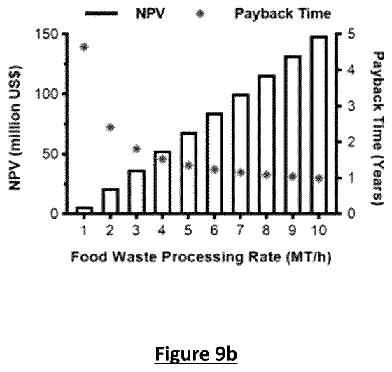

More particularly, two cases have been simulated: a first base case and a high enzyme case. The base case consisted of two production areas, corresponding to food waste (FW) hydrolysis and separation (Area 1) and bio-based polyurethane rigid foam (PURF) synthesis (Area 2). The base and high enzyme cases only differed in terms of the enzyme dosage. The base case adopted cost-effective enzyme dosages discussed earlier (namely, 0.01 v/v % glucoamylase and 0.1 w/v % lipase). The high enzyme case adopted typical enzyme dosages (namely, 1 w/v or v/v % for glucoamylase, protease, and lipase). FIG. 8 shows the process flow of the base case model built in SuperPro Designer v13 software.

Area 1 covered FW hydrolysis and separation. First, the size of the FW was reduced through grinding (P-101/GR-101), and it was mixed with water (P-102/MX-101). It is reported that a solid-to-liquid ratio of 30 w/v % has resulted in more effective hydrolysis for the glucose yield. Because the FW used here already contained 60.04% moisture, it was mixed with water in a ratio of 10:3.32 in the model. Subsequently, after dosing the required amounts of enzymes, hydrolysis was performed at 55° C. for 24 h in a stirred reactor (P-104/R-101). The hydrolysed slurry was then centrifuged into three phases (P-107/DS-101). The crude hydrolysate (aquatic phase) was sold to generate revenue based on the glucose content because it could enable the production of fermentative value-added products. The crude lipids (oil phase) were combined with the remaining solids (solid phase) and sent for solvent extraction (P-108/V-103). When hexane was used, it was dosed at a ratio of 6.66:1 to the lipid fraction. The mixture stream was centrifugated (P-109/DS-102) again to separate the lipid-rich organic phase from the aqueous phase and the remaining solids. The resulting aqueous phase and residual solids were transferred to a protein extraction unit (P-113/GBX-101) to recover proteins at a 50% split ratio, which can be sold as animal feed. The remaining residues were sent for waste treatment. Simultaneously, the lipid-rich organic phase was placed in an evaporator (P-110/EV-101) to concentrate the lipid stream and recover the solvent with a recovery rate of 99.8%. The recovered solvent was transferred to a storage facility (P-112/V-104) for reuse. An additional flow adjuster (P-111/MX-102) was applied to compensate for the solvent lost during evaporation by introducing fresh solvent. In addition to the solvent recycling, the obtained FW lipids (FWLs) were sent to Area 2 for synthesising bio-based polyols and PURF.

Area 2 was aimed at synthesising bio-based polyols and PURF. Epoxidation was first modelled in a reactor (P-202/R-201). After being charged with the FWLs and epoxidation catalyst, the reactor was heated and agitated while added with glacial acetic acid. When the temperature reached 40° C., hydrogen peroxide was gradually added as the temperature raised to 60° C. over 30 min. The mass ratio for FWLs, catalyst, acetic acid, and hydrogen peroxide was 200:40:25.15:127.09. The cycle duration for the epoxidation reactor was 8 hours. The resulting products were washed with warm (40° C.) water (P-204/V-202) in a ratio of 1:1 and separated in a centrifuge (P-205/DS-201). The epoxides (oil phase) were collected in a feed tank (P-206/V-203) for the subsequent ring-opening process, while the aqueous phase and remaining solids were combined and sent for wastewater treatment. Oxirane ring-opening was modelled in a continuously stirred reactor (P-207/R-202) purged with nitrogen gas. Diethylene glycol (DEG) was first added into the reactor and heated to 100° C., and fluoroboric acid (HBF₄) was added as the catalyst. Subsequently, the epoxides were transferred into the reactor while the temperature was raised to 190° C. The mass ratio of FWL-derived epoxides, DEG, and HBF4 was 100:71.42:0.23. The yields were modelled based on the experimental results presented in Section 3.2. This unit procedure also included a distillation operation to separate the desired products and transfer them to a storage tank (P-208/V-204). Moreover, the distillate was collected for waste treatment. The obtained bio-based polyols were stored in a storage unit (P-208/V-204), which also served as the feed tank for further usage. Finally, the polyols were mixed with all other reactants (P-209/MX-201 and P-210/MX-202) for synthesising PURF. The detailed recipe for the PURF is summarised in Table 1.

TABLE 9
Base case techno-economic analysis.
Base Case Summary
(All values in 2024 US$)

| NPV at 7.00% | 148,782,560 | US$ |
|---|---|---|
| ROI | 101.51% | |
| Payback Time | 0.99 | years |
| IRR (after tax) | 107.42% | |
| Food Waste Utilisation Rate | 10 | MT/h |
| | 78,480 | MT/year |
| PURF Production Rate | 25,320.66 | MT/year |

| | |
|---|---|
| Unit Production Cost | US$2.04/kg PU |
| Unit Production Revenue | US$2.81/kg PU |

| Equipment Purchase Cost (US$) | | Material Cost Breakdown (US$/year) | |
|---|---|---|---|
| Hydrolysis Reactor | 441,000 | Food Waste | 3,139,200 |
| Epoxidation Reactor | 391,000 | Glucoamylase | 31,392 |
| Ring-Opening | 366,000 | Lipase | 470,880 |
| Reactor | | Hexane | 476,173 |
| Others | 814,500 | Epoxidation | 1,097,558 |
| Total | 2,012,500 | Catalyst | |
| Capital Investment (US$) | | Acetic Acid | 253,033 |
| Direct Fixed Capital | 11,996,340 | H₂O₂ | 366,158 |
| Working Capital | 4,491,205 | DEG | 2,035,996 |
| Startup and | 599,817 | HBF₄ | 11,215 |
| Validation | | pMDI | 33,413,174 |
| Total Capital | 17,087,362 | TCPP | 2,533,272 |
| Investment | | Other Chemicals | 4,306,185 |
| Operating Cost (US$/year) | | for PU | |
| Materials | 48,153,292 | RO Water | 19,056 |
| Facility-Dependent | 2,260,360 | Total | 48,153,292 |
| Labour-Dependent | 344,760 | Revenues (US$/year) | |
| Laboratory/QC/QA | 51,714 | PURF | 63,301,643 |
| Utilities | 898,380 | Animal Feed | 37,314 |
| Waste Treatment | 6,823 | Hydrolysate | 7,783,645 |
| Annual Operating | 51,715,328 | Total | 71,122,601 |
| Cost | | | |

Table 9 presents the economic overview of the base case, including the PC, TCI, AOC, material cost breakdown, annual revenue, and profitability results. The TCI for the base case model was US$17,087,362. As the key basis for TCI estimation, the PC (US$2,012,500) was mainly generated from the cost of reactors. Considering the significant FW processing rate and recipe cycle time (24 h, consistent with the results presented earlier), nine staggered units of hydrolysis reactors were adopted to accommodate the massive flowrate (13.32 MT/h). Consequently, the FW hydrolysis reactors contributed to 21.91% of the PC. Furthermore, because most of the aquatic fraction was diverted to the hydrolysate stream, the epoxidation reactor (capacity: 31.17 m3) and ring-opening reactor (capacity: 25.10 m3) in Area 2 did not need to accommodate large flowrates of incoming streams. However, as these two reactors were required to be technologically superior to the FW hydrolysis reactor, they accounted for 19.43% and 18.19% of the PC, respectively.

Compared with the TCI, the AOC (US$51,715,328/year) was considerably larger, mainly due to the raw material cost for synthesising PURF (Table 9). The contributions of the raw material cost, FDC, and utility cost to the unit production cost (US$2.04/kg PUR foams; FIG. 7b) were 93.11% (US$1.90/kg), 4.37%, and 1.74%, respectively. Other production costs, including labour-dependent costs, lab/QA/QC costs, and waste-treatment costs, corresponded to only a small proportion of the unit production cost. The chemicals needed to synthesise PURF significantly contributed to the raw material costs. As a key component for PU foaming, pMDI cost US$1.32/kg PURF produced. TCPP, required to decrease the flammability of the PURF, cost US$0.10/kg PURF produced. Together with other chemicals for foaming, the foam development system led to a cumulative cost of US$1.59/kg PURF produced (77.83% of the unit production cost). Additionally, polyol synthesis (including epoxidation and ring-opening) accounted for US$0.15/kg of the production cost. These chemical expenses contributed to the massive AOC and highlighted the material-intensive nature of the FWL-based PURF synthesis scheme.

In terms of the revenue in the base case, selling PURF generated an income of US$63,301,643/year (89.00% of the total revenue). Although the AOC was high, the TCI was small, and the annual revenue could cover the annual cost, resulting in a short payback time of 0.99 y, an NPV of US$148,782,560, an ROI of 101.51%, and an IRR (after tax) of 107.42% in the base case. Therefore, the profitability of the FW hydrolysis and PURF synthesis areas was high, demonstrating the economic competitiveness of the FWL-derived PURF. As a crucial parameter for adjusting future values into present values, the NPV interest was assessed to clarify its influence on the base case profitability. Cumulative cash flow diagrams at different NPV interest rates are illustrated in FIG. 7c. The final cumulative cash flow gradually decreased with an increase in the NPV interest. Nevertheless, due to the substantial NPV at an 11% interest rate, the base case could withstand a significant risk or uncertainty while generating profits, demonstrating the quality of the investment.

In the base case, glucoamylase and lipase were administered at low dosages, contributing minimally to the unit production costs for enzymes (US$0.02/kg PURF). To assess the influence of the reduced enzyme dosages on economic performance, a high enzyme case (1 v/w or w/w % of glucoamylase, lipase, and protease) was established and compared with the base case.

TABLE 10
High enzyme case techno-economic analysis.
High Enzyme Case Summary
(All values in 2024 US$)

| NPV at 7.00% | −16,718,834 | US$ |
|---|---|---|
| ROI | −0.91% | |
| Payback Time | N.A. | |
| IRR (after tax) | N.A. | |
| Food Waste Utilisation Rate | 10 | MT/h |
| | 78,480 | MT/year |
| PURF Production Rate | 25,320.66 | MT/year |

| | |
|---|---|
| Unit Production Cost | US$2.86/kg PU |
| Unit Production Revenue | US$2.81/kg PU |

| Equipment Purchase Cost (US$) | | Material Cost Breakdown (US$/year) | |
|---|---|---|---|
| Hydrolysis Reactor | 470,000 | Food Waste | 3,139,200 |
| Epoxidation Reactor | 391,000 | Glucoamylase | 3,139,200 |
| Ring-Opening | 366,000 | Lipase | 4,708,800 |
| Reactor | | Protease | 13,341,600 |
| Others | 823,000 | Hexane | 476,173 |
| Total | 2,050,000 | Epoxidation | 1,097,558 |
| Capital Investment (US$) | | Catalyst | |
| Direct Fixed Capital | 12,218,888 | Acetic Acid | 253,033 |
| Working Capital | 6,373,133 | H₂O₂ | 366,158 |
| Startup and | 610,944 | DEG | 2,035,996 |
| Validation | | HBF₄ | 11,215 |
| Total Capital | 19,202,965 | pMDI | 33,413,174 |
| Investment | | TCPP | 2,533,272 |
| Operating Cost (US$/year) | | Other Chemicals | 4,306,185 |
| Materials | 68,840,620 | for PU | |
| Facility-Dependent | 2,302,305 | RO Water | 19,056 |
| Labour-Dependent | 356,041 | Total | 68,840,620 |
| Laboratory/QC/QA | 53,406 | Revenues (US$/year) | |
| Utilities | 911,416 | PURF | 63,301,643 |
| Waste Treatment | 7,384 | Animal Feed | 38,765 |
| Annual Operating | 72,460,173 | Hydrolysate | 7,783,645 |
| Cost | | Total | 71,124,053 |

As shown in Table 10, in the high enzyme case, the annual cost of enzymes surged to US$9,189,600/year, directly diminishing the profitability of the simulated plant. As demonstrated earlier, as an increase in enzyme dosage did not lead to significant benefits in terms of nutrient recovery, the annual revenue did not change in the high enzyme case. Moreover, the viability of this case worsened with the increase in the TCI, particularly for the working capital. Consequently, the unit production revenue (US$2.81/kg) failed to cover the unit production cost (US$2.86/kg). Ultimately, the high enzyme case had a negative NPV and was not profitable.

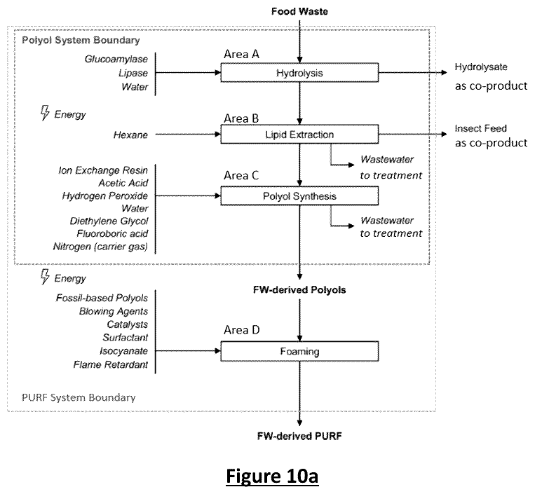

After demonstrating the importance of applying cost-effective enzyme dosages for the base case, a sensitivity analysis was performed to identify other cost drivers for the proposed FW biorefinery. The rationales for the chosen minima/maxima of selected variables can be found in Table 5, and the sensitivity analysis results are illustrated in FIG. 9a, in terms of the variation in NPV (statistics are outlined in Table 11).

TABLE 11
Sensitivity analysis for the base case, expressed in NPV
(US$). Rationales of the chosen parameters can be found
in Table 5. Selected statistics are presented in FIG. 7c.

| Parameters | Low | Base | High |
|---|---|---|---|
| PURF Selling Price | 49,400,903 | 148,782,560 | 248,164,218 |
| pMDI Purchase Price | 201,602,872 | 148,782,560 | 95,962,249 |
| TCPP Purchase Price | 152,787,214 | 148,782,560 | 144,777,907 |
| Purchase Price of Other | 155,589,876 | 148,782,560 | 141,975,245 |
| Chemicals for PUR Foams | | | |
| Lipid Content in the FW | 121,015,612 | 148,782,560 | 176,619,221 |
| FW Cost | 153,745,080 | 148,782,560 | 143,820,041 |
| DEG Purchase Price | 152,001,109 | 148,782,560 | 145,564,012 |
| Epoxidation Catalyst | 150,517,606 | 148,782,560 | 147,047,515 |
| Purchase Price | | | |
| Major Equipment | 150,465,594 | 148,782,560 | 147,110,497 |
| Purchase Cost | | | |
| Lipase Purchase Price | 149,526,938 | 148,782,560 | 148,038,183 |
| Glucoamylase | 148,832,186 | 148,782,560 | 148,732,935 |
| Purchase Price | | | |
| Acetic Acid | 149,182,561 | 148,782,560 | 148,382,560 |
| Purchase Price | | | |
| Hydrogen Peroxide | 149,361,391 | 148,782,560 | 148,203,730 |
| Purchase Price | | | |
| HBF₄ Purchase Price | 148,800,290 | 148,782,560 | 148,764,831 |
| Hexane Purchase Price | 149,535,306 | 148,782,560 | 148,029,815 |
| RO Water Purchase Price | 148,812,685 | 148,782,560 | 148,752,436 |

The selling price of the PURF was the key contributor to the base case profitability, as also highlighted in other TEA studies focused on PU production. For instance, the NPV plummeted from US$148,782,560 to US$49,400,903 when the selling price of the PURF decreased from US$2.5/kg to US$2/kg. The minimum selling price of the PURF was US$1.76/kg in the base case. A further decrease in the selling price was expected to diminish the profitability.

In addition, as mentioned previously, the cost of materials, particularly the chemicals needed for PURF, played essential roles. If the purchase price of pMDI increased from US$2.5/kg to US$3/kg, the NPV was expected to decrease by US$52,820,311. In addition to the chemicals needed to form PURF, the materials for epoxidation and oxirane ring-opening also influenced the sensitivity of the base case. For example, in the context of DEG, a 20% decrease in the purchase price (from US$0.83/kg to US$0.66/kg) could lead to a rise in the NPV from US$148,782,560 to US$152,001,109. Notably, because hydrolytic enzymes for FW were dosed at cost-effective dosages, the market status for glucoamylase and lipase did not significantly influence the profitability of the base case. It must be noted that, in the current study, the chemicals used during the experiments were still adopted for analysis. However, in real-world scaled-up situations, more aspects should be considered, such as accessibility and risks of the materials, rather than the best experimental performance. Taking HBF₄, the catalyst for the oxirane ring-opening reaction, as an example, alternatives can be considered in an upscaled process, such as 1,8-diazabicyclo [5.4.0]undec-7-ene (DBU), although HBF₄ appears to be highly effective. In addition, H₂SO₄ can also be considered on an industrial scale as it is the most convenient epoxy ring opening reagent. Nevertheless, adopting H₂SO₄ into the proposed valorisation scheme needs to be extensively examined as it tends to oxidise the polyols and yield undesirable side reactions.

Interestingly, the lipid content within the original FW also impacted the economic performance of the base case, indicating the economic risks associated with the variation in FW derived from different sources or in different seasons. Even with a slight increase in the lipid content of the FW (from 5.43% to 8.15% on a wet basis), the NPV remarkably surged from US$121,015,612 to US$176,619,221.

In terms of the TCI, the sensitivity of the PC was not severe. For example, with a 20% increase in the PC, the NPV changed by US$1,672,063 over the 20-year project lifetime. This outcome was consistent with earlier discussion, highlighting the material-intensive nature of producing FWL-derived PUR foams.

Notably, the FW processing rate, linked to the scale of the simulated FW biorefinery, significantly affected the base case profitability, as demonstrated in FIG. 9b. With a decrease in the FW processing rate (from 10 to 1 MT/h), the NPV gradually decreased, and the payback time increased. As a production route with more physio-chemical unit procedures, scaling up led to increased profitability, consistent with the scale effect reported in another TEA study of a mango processing waste biorefinery.

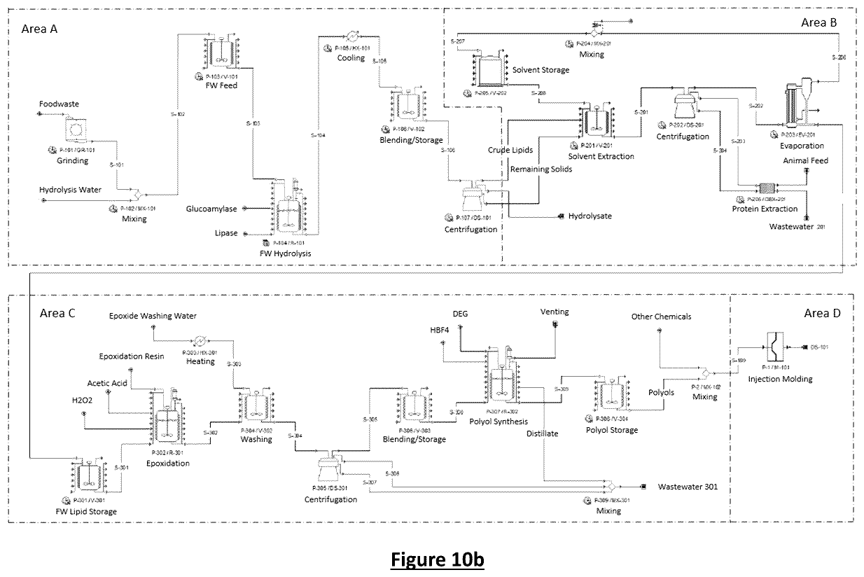

In a second embodiment, a second base case has been proposed and simulated, as shown in FIG. 10a). Briefly, the polyol system consisted of three areas, namely FW hydrolysis (Area A), lipid extraction (Area B), and polyol synthesis (Area C). After enzymatic hydrolysis of FW, hydrolysate (aquatic phase), as a co-product, was separated via centrifugation. The crude lipids (oil phase) and remaining solids (solid phase) were subjected to solvent extraction. While the extracted lipids were subjected to subsequent procedures for polyol synthesis, the remaining solids underwent a protein extraction process and were finally sold as insect feed. In Area C, the lipids were transformed into bio-based polyols via stepwise epoxidation and oxirane ring-opening. In the expanded PURF system, FW-derived polyols, analysed as a single product, were mixed with other chemicals and underwent foaming (Area D) to obtain PURF. Mass and energy were balanced throughout the processes, with assistance from SuperPro Designer. In this multi-functional system, hydrolysate and insect feed were co-produced along with the polyols (Area A and Area B, respectively).

More particularly, and as shown in FIG. 10b, Area A covered food waste (FW) hydrolysis. First, the size of the FW was reduced through grinding, and it was mixed with water. It has been reported that a solid-to-liquid ratio of 30 w/v % results in effective hydrolysis for the glucose yield. Because the FW used in our earlier work already contained 60.04% moisture, it was mixed with water in a ratio of 10:3.32 in this model. Subsequently, after dosing the enzymes at cost-effective dosages (0.01% glucoamylase and 0.1% lipase), hydrolysis was performed at 55° C. for 24 h in a stirred reactor. The hydrolysed slurry was then centrifuged into three phases. The crude hydrolysate (aquatic phase) was sold to generate revenue based on the glucose content because it could enable the production of fermentative value-added products. The crude lipids (oil phase) were combined with the remaining solids (solid phase) and sent for solvent extraction in Area B.

Area B covered lipid extraction from the crude lipids and the remaining solids. When hexane was used as the extraction solvent, it was dosed at a ratio of 6.66:1 to the lipid fraction (Intelligen). The mixture stream was centrifuged again to separate the lipid-rich organic phase from the aqueous phase and the remaining solids. The resulting aqueous phase and remaining solids were transferred to a protein extraction unit to recover proteins at a 50% split ratio, which could be sold as insect feed. The remaining residues were sent for waste treatment. Simultaneously, the lipid-rich organic phase was placed in an evaporator to concentrate the lipid stream and recover the solvent with a recovery rate of 99.8% (Intelligen). The recovered solvent was transferred to a storage facility for reuse. An additional flow adjuster was applied to compensate for the solvent lost during evaporation by introducing fresh solvent. In addition to solvent recycling, the obtained FW lipids (FWLs) were sent to Area C.

Area C was aimed at synthesising bio-based polyols. First, epoxidation in a reactor was modelled. After being charged with the FWLs and epoxidation catalyst, the reactor was heated and agitated while glacial acetic acid was added. When the temperature reached 40° C., hydrogen peroxide was gradually added as the temperature was raised to 60° C. over 30 min. The mass ratio for FWLs, catalyst, acetic acid, and hydrogen peroxide was 200:40:25.15:127.09. The cycle duration for the epoxidation reactor was 8 hours. The resulting products were washed with warm water (40° C.) at a ratio of 1:1 and separated in a centrifuge. The epoxides (oil phase) were collected in a feed tank for the subsequent ring-opening process, while the aqueous phase and remaining solids were combined and sent for wastewater treatment. Oxirane ring-opening in a continuously stirred reactor purged with nitrogen gas was modelled. Diethylene glycol (DEG) was first added to the reactor and heated to 100° C., with fluoroboric acid (HBF4) added as the catalyst. Subsequently, the epoxides were transferred into the reactor while the temperature was raised to 190° C. The mass ratio of FWL-derived epoxides, DEG, and HBF4 was 100:71.42:0.23. This unit procedure also included a distillation operation to separate the desired products and transfer them to a storage tank. Moreover, the distillate was collected for waste treatment. The obtained bio-based polyols were stored in a storage unit, which also served as the feed tank for further usage.

Finally, the bio-based polyols were mixed with other reactants in Area D to synthesise PURFs. Apart from the FW-derived polyols, the polyol system included a fossil-based polyol product, Lupranol® 3422. Tris (1-chloro-2-propyl) phosphate was used as the flame retardant. The blowing agents (which may be a pentane) included Opteon™ 1100 and water. The catalysts for the foaming process included PC CAT® TKA 30 and PC CAT® NP10, and Niax™ Silicone L-6915 was used as the surfactant. Regarding the isocyanate fraction, polymeric 4,4′-methylene diphenyl isocyanate was used.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention, which are, for brevity, described in the context of a single embodiment, may also be provided separately or in any appropriate sub-combinations.

1. A method of forming polyols from food waste, including:
hydrolysing an amount of food waste,
extracting lipids from said hydrolysed food waste, and
forming polyols from said lipids.

2. The method of claim 1, said hydrolysing an amount of food waste is carried out in the presence of at least one enzyme.

3. The method of claim 2, wherein said at least one enzyme is selected from a group consisting of glucoamylase, neutral protease and lipase.

4. The method of claim 1, wherein said forming said polyols from said lipids is carried out by epoxidation and oxirane ring-opening of said lipids.

5. The method of claim 4, wherein said epoxidation is carried out by reacting hydrogen peroxide, glacial acetic acid, with said lipids in the presence of an ion exchange resin.

6. A method of forming polyurethane rigid foams, including forming polyols according to the method of claim 1, and forming polyurethane rigid foam with said polyols.

7. The method of claim 6, further including mixing said polyols with at least one of an isocyanate, a flame retardant, a blowing agent, a catalyst, and a surfactant.

8. The method of claim 7, wherein said flame retardant includes tris(1-chloro-2-propyl) phosphate.

9. The method of claim 7, wherein said isocyanate includes polymeric 4,4′-methylene diphenyl isocyanate.
